(19) United States
(12) Patent Application Publication
(10) Pub. No.: US 2005/0126631 A1
(43) Pub. Date: Jun. 16, 2005

(54) Catv fire fighting vehicle

(76) Inventor: Stanley M. Gorman JR., Wallar, TX (US)

Correspondence Address: THE MATTHEWS FIRM, 2000 BERING DRIVE, SUITE 700, HOUSTON, TX, 77057, US

(21) Appl. No.: 10/892,891

(22) Filed: Jul. 16, 2004

Related U.S. Application Data
(60) Provisional application No. 60/488,547, filed on Jul. 18, 2003.

(51) Int. Cl. E03B 1/00; F17D 3/00; F16L 43/00

(52) U.S. Cl. 137/128; 137/129; 137/130

(57) ABSTRACT

An all terrain vehicle adapted preferably, but not exclusively, for use in fire-fighting and emergency rescue in remote areas or other areas normally inaccessible to conventional fire and rescue vehicles. The vehicle comprises front and rear units connected by an articulating joint to improve vehicle mobility and agility. The vehicle further preferably comprises at least one pump, at least one hose and nozzle, at least one storage reel for the hose or hoses, at least one fluid tank, and at least one foam tank and foam mixer.

### RELATED APPLICATION

This application claims priority from United States Provisional Patent Application Ser. No. 60/488,547 having a filing date of Jul. 18, 2003.

### FIELD OF THE INVENTION

The present device relates to mobile fire-fighting equipment. More particularly, the present device relates to fire fighting and rescue equipment mounted on a vehicle for accessing remote areas not conducive for access by traditional fire-fighting and rescue vehicles.

### BRIEF DESCRIPTION OF THE DRAWINGS

FIG. 1 is an illustration of a side pictorial view of the vehicle and related equipment according to the present invention;

FIG. 2 is an illustration of a rear pictorial view and partial side pictorial view of the vehicle and related equipment according to the present invention;

FIG. 2A is an illustration of a pictorial view of an alternative embodiment of a the vehicle and related equipment according to the present invention;

FIG. 3 is an illustration of the front unit of the embodiment shown in FIG. 1 with a safety cage and related equipment according to the present invention;

FIG. 4 is an illustration of a pictorial view of a removably attached carrier and related equipment according to the present invention; FIG. 4A is an illustration of a pictorial view of a removably attached side mounted carrier and related equipment according to the present invention;

FIG. 5 is an illustration of a pictorial side view of an alternative embodiment with removably attachable trailers and related equipment according to the present invention;

FIG. 6 is an illustration of a front elevated view of an alternative embodiment for rail travel and related equipment according to the present invention;

FIG. 7 is an illustration of a front elevated view of an alternative embodiment for rail travel and related equipment according to the present invention;

FIG. 8 is an illustration of a side pictorial view of an alternative embodiment with tracks and related equipment according to the present invention;

FIG. 9 is an illustration of a side pictorial view of an alternative embodiment illustrating tracks for only the front unit and wheels for the rear unit and related equipment according to the present invention;

FIG. 9A is an illustration of a side pictorial view of an alternative embodiment illustrating separate tracks for the front unit and for the rear unit and related equipment according to the present invention;

FIG. 10 is an illustration of a side pictorial view of an alternative embodiment illustrating tracks for the rear unit and a ski for the front unit and related equipment according to the present invention;

FIG. 11 is a general schematic illustration of the flow/function of the tanks/pumps and related equipment according to the present invention;

FIG. 12 is an illustration of a partial side pictorial view, partially cut-away of the vehicle and related equipment according to the present invention;

FIG. 13 is an illustration of a pictorial side view of an alternative embodiment illustrating an embodiment of a sky hook attachment and related equipment according to the present invention.

### DETAILED DESCRIPTION OF EMBODIMENTS

It should be noted that throughout the following disclosure the term water and water tank are used for ease of understanding and identifying features and functions of the present device. However, it should be readily apparent that the water tank can contain any fluid particularly one that is conducive as a fire-retardant liquid. It should therefore also be apparent that if the fluid in the water tank is something other than water or a mixture of water and some other fluid, then such fluid will also flow through the pump and through piping or hoses in fluid communication with the pump and/or tanks.

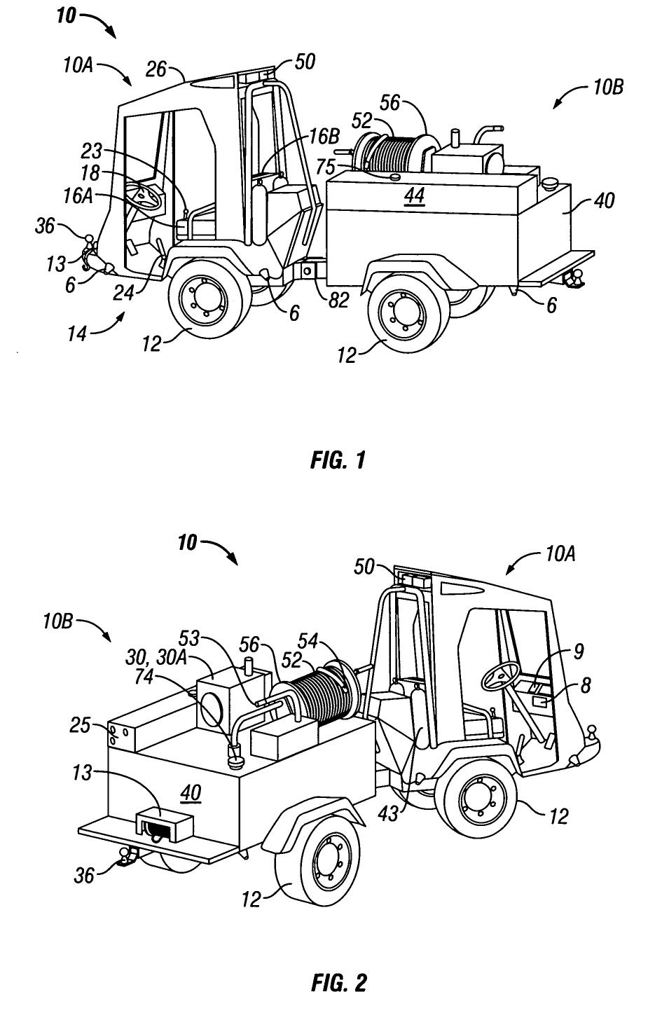

FIG. 1 illustrates one embodiment of the present invention. As can be seen, the vehicle 10 is preferably a cargo all terrain vehicle specifically designed to carry loads in addition to personnel. Thus, vehicle 10 is designed to traverse rough terrain as well as gain access to other areas typically inaccessible to typical cargo carrying vehicles including, but not limited to, trucks, cars, utility vehicles, and traditional fire-fighting or rescue vehicles. These inaccessible areas may be unpaved or unimproved terrain or can be areas of narrow access such as narrow streets, alleys, bicycle paths, trails, or similar access routes.

Preferably, vehicle 10 has four wheels 12 but it should be appreciated that another embodiment can have more or less than four wheels, for example three wheels. Vehicle 10 preferably has a front unit 10A and a rear unit 10B. A passenger compartment 14, preferably in front unit 10A, is preferably comprised of at least two seats 16A and 16B. Preferably, seat 16A is for a driver and seat 16B is for a passenger. It should be appreciated that the use of seats 16A and 16B can be interchanged with the driver's seat being either on the right side or on the left side (16A or 16B). It is understood that the present device could be configured to have driving/steering capabilities for both seats 16A and 16B wherein the vehicle could be driven/steered from either seat 16A or 16B or from both seats 16A or 16B. The passenger compartment 14 further comprises at least one steering wheel 18, and preferably conventional type pedals (not illustrated) for power, braking, and a clutch pedal to facilitate gear shifting. Still further, the passenger compartment 14 would preferably include a gear shift 23 which may be a stick, a foot actuated pedal, or a similar device. Preferably, a manual or hand brake 24 is also in the passenger compartment 14. It should be obvious that if an embodiment with an automatic transmission is utilized that a clutch pedal may not be necessary.

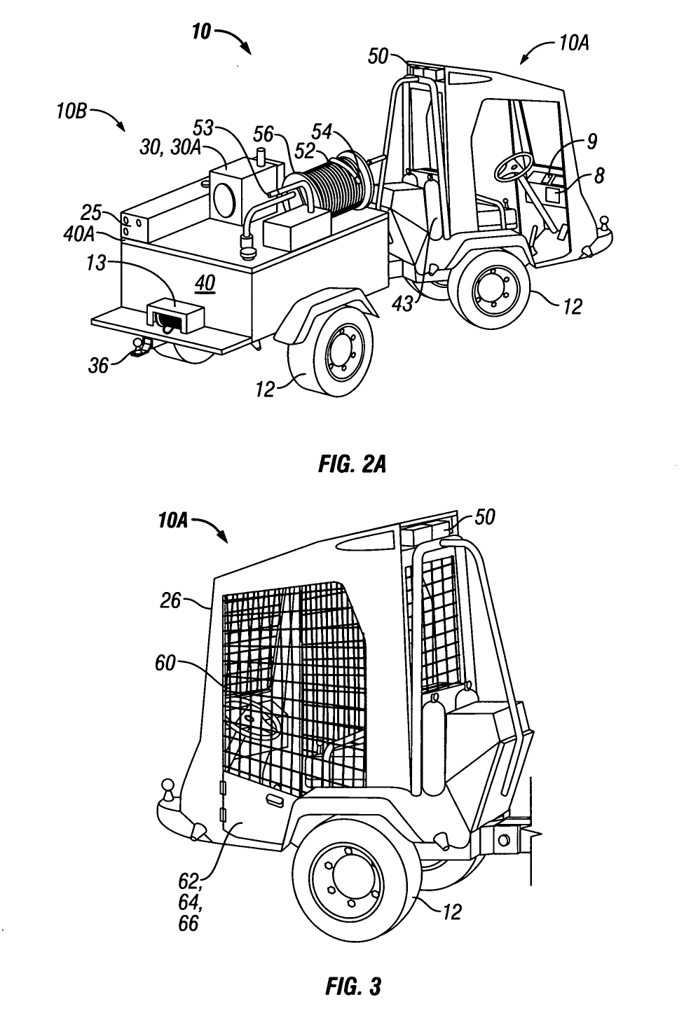

In some embodiments, the passenger compartment 14 further comprises a control panel 9 (FIG. 2). The control panel 9 preferably includes, but is not limited to various gauges indicating fuel tank level, water tank level, foam tank level, amount of pump/generator fuel, and air tank pressure. It should be understood that the control panel 9 could further include switches for energizing and de-energizing the pump/generator 30 and 30A and controlling flow from the various tanks including, but not limited to, water tanks 40, compressed air tanks 7 (FIG. 12), and foaming agent tanks 44. It should be appreciated that the control panel 9 could be limited to energizing and de-energizing switches without additional gauges or indicators. It should be further understood that the tanks, except for the compressed air 7 or breathing air tanks 43, can also have built-in site glasses to indicate the contents level. It should be appreciated that site glasses and gauges can be used exclusive of one another or in combination. Another embodiment can further include tracking aids 8 (FIG. 2) such as a compass, G.P.S. instrumentation, for aiding navigation as well as provide positive location of the vehicle 10, radios, and cellular telephones which are incorporated into the control panel 9 or are independently attached in the passenger compartment 14 or attached, fixedly or removably, elsewhere on or in vehicle 10.

In another embodiment, a control panel 25 (see FIG. 2) is attached in the rear unit 10B. Control panel 25 can have some redundant features of the front control panel 9 or can be wholly independent of the front control panel 9. In either case, control panel 25, would preferably include, but not be limited to, switches for the pump and/or generator 30 and 30A (FIG. 2), level indicators for the water tank 40 and foaming agent tank 44, controls for introducing the foaming agent into the pump discharge stream, and any switches for additional lighting.

The passenger compartment 14, is preferably at least partially enclosed by frame 26 (FIG. 1). Frame 26 is preferably a roll over frame and will protect the occupants from injury and to some extent, protect the passenger compartment 14 from damage in case the vehicle 10 rolls or turns over. The frame 26 can also serve to protect the occupants from brush, limbs, rocks, and the like through which or next to which the vehicle 10 travels. The frame 26, if so desired or required, can have safety lights and sirens (not illustrated), emergency lights 50, extra flood lights (not illustrated) or the like attached to it. It should be appreciated that such lights can also be attached elsewhere on vehicle 10 in order to increase visibility of the vehicle 10 or to provide lighting for the users of the present device. The controls for such lights are preferably mounted in the passenger compartment 14 either on the control panel 9 or separately within the passenger compartment 14. Additionally, redundant controls for such lights may be part of outside control panel 25 or located elsewhere on or in the rear unit 10B of vehicle 10.

The frame 26 can further be comprised of a cage 60 (see FIG. 3) to further protect the occupants. It should be appreciated that such a cage 60 may include doors 62, windows 64, heat shields 66, and the like. It should be appreciated that the heat shields 66 could be of many configurations and in many positions. Typically, the heat shields 66 are to protect the occupants from excessive heat as they are driving near or through fire. The heat shields 66 are preferably installed as door panels, either instead of the cage component, combined with a cage component, or installed, in an embodiment where, a cage 60 is not utilized. It should be appreciated that the heat shields can be installed as part of any window, of course being careful not to obstruct the driver's view, as a part of the vehicle roof, floor or walls, or as necessary for the particular environment in which an embodiment will be placed into operation. The heat shield 66 can be of a variety of heat resistant materials or can be sheets of metal which sandwich heat resistant cloths, fibers, materials, and the like. It should further be appreciated that access to and from the passenger compartment should be easy and any cage, door, window, seat or safety belt, and the like should be easy to open or remove in case that the occupants must enter or leave the vehicle quickly. It must also be obvious that the material for any windows or windshields must be adapted to the environment in which the vehicle 10 will be operated. Thus, glass may not be conducive to rough terrain areas, untempered glass would not be conducive to high heat areas and any full-cover and transparent windshield or window may not be conducive to areas where mud and smudge are likely to be splashed on such window or windshields. It should be appreciated that FIG. 3 is only an illustration and is not intended to limit the placement, size, material, or orientation of the cage 60, windows 64, heat shield 66, doors 62, and the like.

In one embodiment, the rear of the passenger compartment 14 preferably contains at least one compressed air tank 7 (FIG. 12). The compressed air tank 7 can be used to operate any necessary portable air tools (not illustrated). It should be appreciated, by those in the art, that many rescue and/or emergency tools including, but not limited to, saws, jack hammers, jacks and lifts, and cutters/spreaders (for cutting open crashed vehicles, airplanes, and the like) can be operated by pneumatic or hydraulic power. Thus, the compressed air tank 7 or a hydraulic system, similar to one conventionally required to operate vehicle brakes, can preferably be used to operate such rescue tools and equipment. In one embodiment, the foaming agent dispensing is through the use of compressed air, such as a Compressed Air Foam System 81 (FIG. 12), to deliver the foaming agent into the water stream as opposed to utilizing the venturi effect to urge the foaming agent into the water stream. FIG. 12 illustrates the Compressed Air Foam System 81 along with associated connection hoses 81a. It is further understood that the passenger compartment 14 may include tanks for breathing air 43 (FIG. 2). These breathing air tanks 43 can be wholly portable or have extendable hoses which allow a breathing apparatus to be used by personnel inside or outside the vehicle.

The rear unit 10B is connected to the front unit 10A via an articulating joint 82 (FIG. 12) which allows for improved maneuverability and agility of the vehicle 10. The articulating joint 82 preferably includes a drive shaft 82a. It should be understood, by those skilled in the art, that the articulating joint 82 may consist of a tube, of various cross-sectional configurations, plates, or other mechanisms that would provide some flexibility to allow the desired maneuverability and agility of the vehicle. Still further, it should be understood that the drive shaft 82a, which preferably provides the rotational power to the wheels 12, should be substantially enclosed by or otherwise work in tandem with the articulating joint 82 to allow the desired flexibility of the articulating joint 82. It would thus be well known, to those skilled in the art, that the drive shaft 82a may contain some combination of u-joints and struts to achieve the desired flexibility of the overall joint. For the purpose of clarity and convenience, the articulating joint 82, described herein, shall be deemed to include the drive shaft 82a. As the design of the articulating joint 82 is known, it will not be described in further detail herein.

The rear unit 10B is preferably equipped with a high pressure pump 30 and generator 30A, at least one hose 52 and nozzle 54, at least one storage reel 56 for the hose 52 or hoses, at least one water tank 40, and at least one foaming agent tank 44, and foam mixer 45. Preferably, hose reel 56 is an automatic reel that allows easy and efficient unwinding and winding of hose 52. The reel 56 power source can be, but is not limited to, hydraulic, electric, pneumatic, or a combination of power sources. It should be appreciated that the reel can be manual as well. In another embodiment, the rear unit 10B can also include a storage box (not illustrated), preferably for tools and other necessary equipment. It should be appreciated that the pump 30 and generator 30A may be one unit or may be separate units and can vary in output. It should be further appreciated that although FIG. 2 shows only one of each of the above listed features, the configuration can be varied to include some or all of these features as well as multiples of some features, a variety of different capacity tanks can be included, or even additional features such as water cannons (not illustrated) or the ability to pump water from sources other than the water tank 40 may be included.

In another embodiment, illustrated in FIG. 2A, the vehicle 10 may be adapted with a second frame 40a detachably mounted over the water tank 40 such that the second frame 40a may be removed from the rear unit 10B. This second frame 40a, would be attached to the frame of the rear unit 10B, in a conventional manner to allow detachment with relative ease. The features, described herein as mounted to the rear unit 10B, may be mounted to the second frame and thus be removable with the second frame 40a when desired. Preferably, at least in this embodiment, the top of the water tank 40 is of sufficient construction to support the weight of at least two persons and with the second frame 40a being removed, the vehicle 10 can transport casualties or injured personnel from an emergency or rescue scene.

The pump 30 and generator 30A whether one unit or separate units, can be fueled from the same tank as vehicle 10, can have a separate tank (not illustrated) to fuel the pump 30 and the generator 30A, or each of the vehicle engine 80 (FIG. 12), pump 30, and generator 30A can have separate fuel tanks. It should also be understood that the fuel tank level indicators (not illustrated) can be gauges or sight glasses mounted directly on the tanks or they may be gauges mounted on the passenger compartment control panel 9, on the control panel 25, or can be any combination of indication as set forth herein.

Both the front unit 10A and the rear unit 10B preferably include a receiver hitch adaptor 36 (FIGS. 1 and 2). This adaptor allows for the removable attachment of features of additional embodiments. It should be appreciated that the receiver hitch adaptor 36 may be of a variety of configurations including a conventional hitch receiver, the function of which is to connectably adapt the vehicle 10 for a variety features detachably connectable by such a hitch receiver 36. It should be further appreciated that a conventional winch 13 may be mounted to either the front of the front unit 10A or to the rear of the rear unit 10B. Such a conventional winch 13 may be utilized to pull in objects surrounding the vehicle 10 including, but not limited to, logs, trees, persons, animals, and other vehicles. The conventional winch 13 may also be used to extricate the vehicle 10 should it become stuck or entangled in water, mud, underbrush, trees, limbs, and the like.

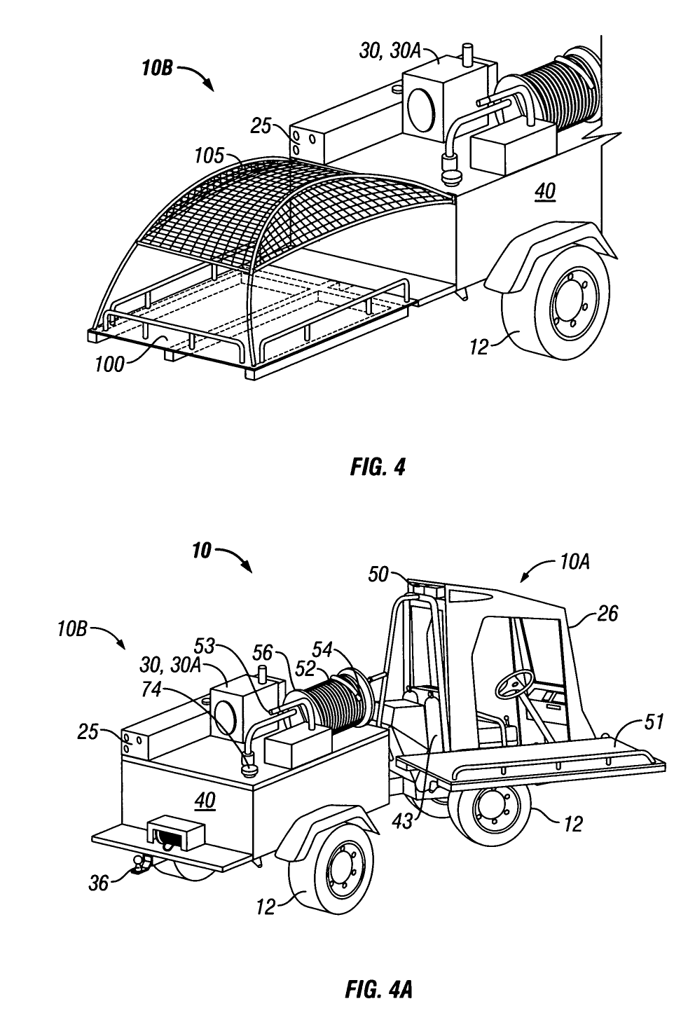

FIG. 4 illustrates an embodiment, of the present invention, with a personnel carrier 100 which is preferably removably attached to the receiver hitch 36. This carrier 100 is preferably utilized to carry injured or disabled persons to safety. It should be appreciated, that as illustrated, the carrier 100 is best suited for carrying casualties or injured persons preferably in a prone position such as on a stretcher. It can also be configured to carry extra fire-fighting or emergency personnel. Such a carrier 100 could also include a protective cage 105 and necessary safety belts (not illustrated) to secure any personnel carried within. In another embodiment, a carrier can be attached which carries additional fire-fighting or emergency equipment, tools, supplies, and the like. Another embodiment can have the carrier 100 attached to the front of front unit 10A or still another embodiment could have such a carrier 100 on both the back and front of the vehicle 10. It should be understood that any combination of personnel carriers is within the scope of this invention. This scope would encompass any carriers 51 or stretchers that could be attached to the side of the vehicle (FIG. 4A). It should be appreciated by those in the art that any such side mounted stretchers would preferably be supported from the frame 26 or from the frame 26 and the rear unit 10B. It should be further appreciated that carriers 51 are preferably for moving victims or casualties in a substantially prone position.

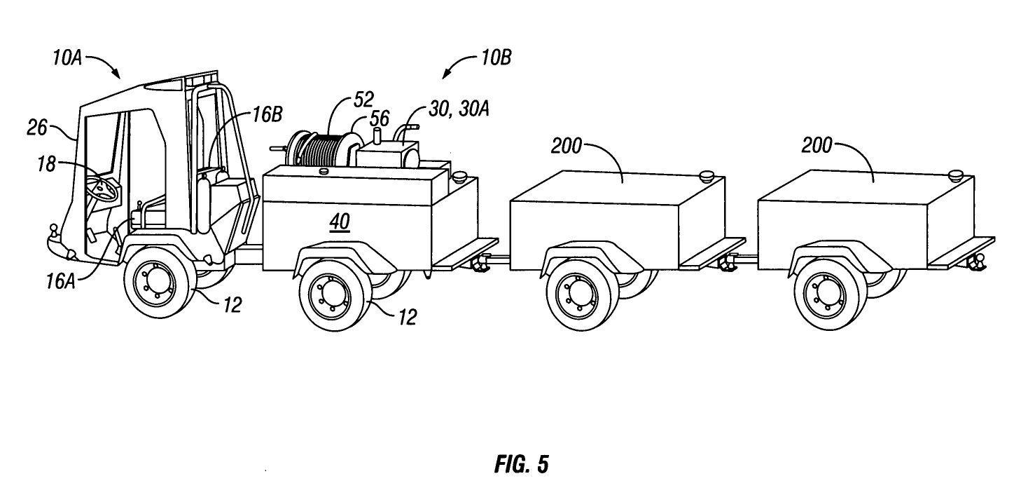

In another embodiment, illustrated in FIG. 5, the receiver hitch 36 can be utilized to connect additional carts or trailers 200. These additional carts or trailers 200 can also be utilized to carry additional fire-fighting or emergency equipment, tools, supplies, water tanks, foam tanks, pumps, generators, and the like. It is also envisioned that such additional carts or trailers 200 could be utilized for evacuating personnel, injured or otherwise, as well as transporting additional personnel.

The water tank 40 (FIG. 2) and foaming agent tank 44 (FIG. 1) each preferably have a cap 74, 75 for filling each tank, and a drain (not illustrated) for emptying or cleaning each tank. Additionally, the tanks 40 and 44 will preferably have some partitions or baffles (not illustrated) in the tanks to prevent the tank contents from sloshing or shifting such as to create a weight shift sufficient to adversely affect the stability of vehicle 10. Such baffles or partitions must not restrict or prevent the outlet flow of the contents therein. It should also be readily apparent that the necessity of the baffles or partitions is a factor of the size and the capacity of the particular tank, and of the material or fluid contained therein.

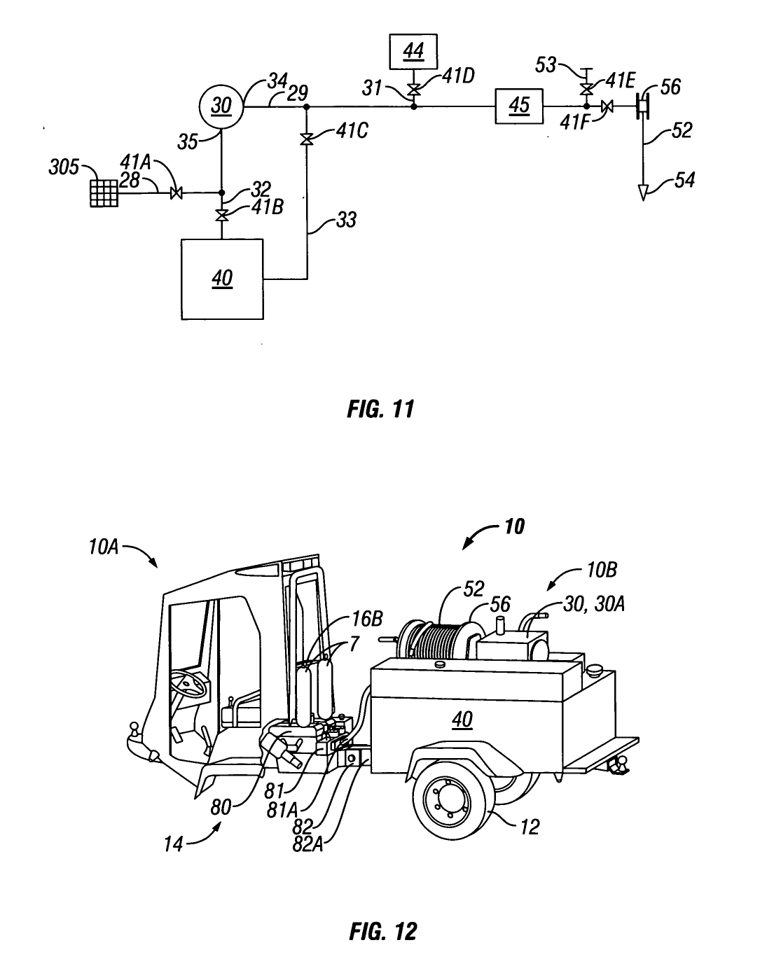

FIG. 11 illustrates a typical schematic of the fluid flow of the current invention. The pump 30 preferably has a discharge 34 and a suction intake 35. Preferably, pump 30 can intake fluid from water tank 40, through intake line 32 or from an external water supply through intake line 28. Pump 30 can also intake fluid through intake line 28 and fill the water tank 40 through pump discharge 34 and discharge line 33.

In use, pump 30 intakes fluid from either tank 40 through intake line 32 or from an external water supply through intake line 28. The pump 30, preferably discharges the fluid through discharge 34 into the discharge line 29. The discharge line 29 is preferably in fluid communication with hose 52 and secondary outlet 53 wherein either or both hose 52 or secondary outlet 53 discharge the fluid in the required direction. Foaming agent tank 44 is preferably in fluid communication with the discharge line 29 through tank discharge line 31. Preferably, the tank discharge line 31 includes a valve 41D that controls the opening percent of tank discharge line 31. Preferably, the foaming agent does not freely flow into discharge line 29. Preferably, the foaming agent is drawn into the discharge line 29 through a venturi effect due to the discharge line pressure/flow or by a mechanical pumping action energized by the venturi effect or a combination of both. It should be appreciated that the amount of foaming agent drawn into the discharge line 29 is also a function of the percentage of valve 41D opening. Preferably, the foaming agent and the fluid further mix in the foam mixer 45. It should be noted that foam mixer 45, sometimes referred to as a foam eductor, is optional as the foam and fluid will also substantially mix as they are discharged through hose 52 and nozzle 54 or through 15 secondary discharge 53.

The fluid pumping circuit, as illustrated in FIG. 11, preferably includes a number of control valves identified as 41A-41F. It should be appreciated that this is not a limiting description for any embodiment disclosed herein as the type of valve, the number of valves, and the placement of these valves is dependent on individual pumping circuit design and as such should not be construed as a limitation of the current device.

It should be appreciated that other embodiments can combine the foaming agent tank 44 with the water tank 40 or can insert the foaming agent tank 44 into the water tank 40, such as the Compressed Air Foam System 81 (FIG. 12). It should further be appreciated that the foam mixer 45 can also be the discharge piping and/or the hose 52 as the foaming agent and the fluid can mix while flowing through the discharge piping and hose 52 and thus be discharged through the hose nozzle 54 as foam. The hose 52 will preferably have a nozzle 54 attached to the one end of the hose 52 and such nozzle 54 will control the fluid flow through the nozzle 54. It should still further be appreciated, by those in the art, that some foaming systems do not require separately carrying the foaming agent. For example, not intended as limiting, one conventional foaming system allows for the foaming agent to be added directly to the water tank 40. This particular foaming agent mixes with the water and maintains its fluid structure while being moved through the pump 30 and through any hose 52 or discharge 53. Preferably, the foaming agent reacts as the water and foaming agent are discharged through the nozzle 54 and are mixed with the air. It should be understood that the utilization of a foaming agent added directly to the water tank 40 would eliminate the requirement for a foaming agent tank 44 and a foam mixer 45. However, for the purpose of redundancy or for use in non emergency or non fire-fighting applications, the foaming agent tank 44 and the foam mixer 45 may still be retained.

In at least one embodiment, the vehicle 10 has spray nozzles 6 (FIG. 1) permanently or removably attached to the front of vehicle 10, to the back of vehicle 10, to either side of the vehicle 10, underneath the vehicle 10, or in any combination of the locations herein listed. These nozzles 6 will allow foam and/or water to be discharged while the vehicle 10 is in motion to either put out fire underneath or in direct proximity of the vehicle 10. Preferably, these nozzles 6 will be positioned as to discharge the water and/or foam at some angle greater than perpendicular to the plane of substantially 15 horizontal travel of the vehicle 10. It should be appreciated that any spray nozzles 6 attached underneath the vehicle 10 can be effective even if they are positioned substantially perpendicular to the horizontal plane of the ground.

It is also understood that in at least one embodiment, at least one vehicle occupant can hold, maneuver, and control the hose 52 or a hose in fluid communication with the secondary discharge 53 or other additional hose that may be attached to the pump discharge line 29 while the vehicle 10 is moving and thus direct the discharge from the nozzle 6 in any direction required. It should be further appreciated by one skilled in the art that preferably all discharge hoses have nozzles 6. Within this same concept, it is envisioned that at least one embodiment may have at least one water cannon that can be controlled by at least one occupant of the vehicle 10 while the vehicle 10 is in motion.

Preferably, in the embodiment, illustrated in FIG. 11, the water tank 40 can be filled from local water sources. If the water source is a body of water including, but not limited to, a lake, pond, ditch, river, or stream, the suction line 28 being in fluid communication with the pump suction 35, preferably has a screen 305 or other filter to prevent debris or contaminants from entering the suction line 28. It should be appreciated that such an embodiment also includes the ability to bypass the water tank 40 and thus pump water from the local source either directly to a secondary hose outlet 53 or through the primary hose 52 preferably including the mixing of the foaming agent into the fluid stream.

Vehicle 10 is preferably powered by a conventional engine 80 (FIG. 12) fueled by gasoline. In another embodiment, the power is preferably supplied by an alternatively fueled engine 80 (FIG. 12) such as diesel. In still another embodiment, the engine 80 (FIG. 12) is powered by other alternative fuels including but not limited to fuel cells, natural gas, propane, electric motor, or a hybrid engine including a combination of differently fueled engines. It should be appreciated that the engine 80 (FIG. 12) selection is preferably based on the service that the vehicle is in, the local availability of fuels, and the hazards associated with using such fuels in any chosen service.

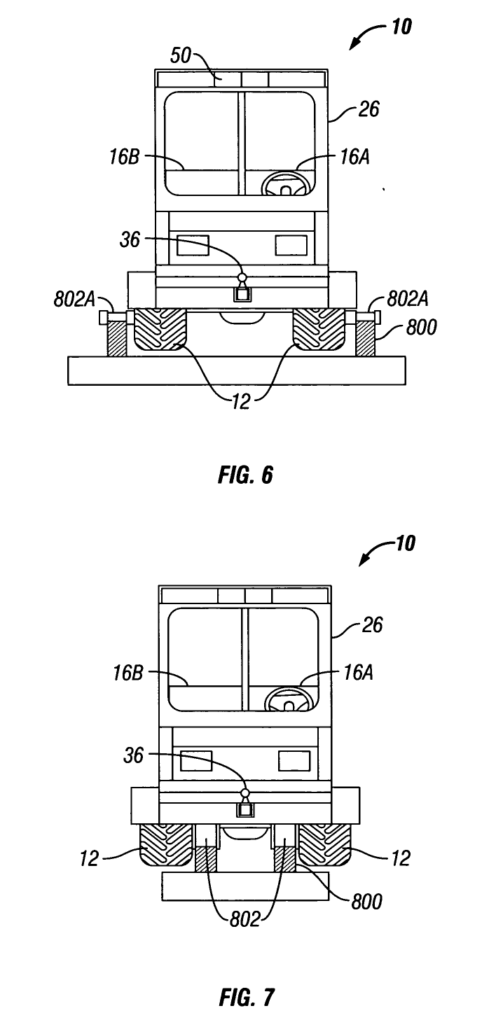

FIGS. 6 and 7 illustrate further embodiments, of the present invention, wherein the vehicle 10 is adapted to travel on rail road tracks 800. FIG. 6 illustrates an embodiment wherein the vehicle is adapted, for rail travel, by preferably attaching adaptor wheels 802A to the outside of the existing wheels 12. It should be appreciated that a variety of attachment methods are possible for the adaptor wheels 802A to the existing wheels 12 including, but not limited to, existing wheel bolting, additional bolting, clamping, welding, riveting, and the like. FIG. 7 illustrates a variation of this embodiment wherein the adaption includes at least one second set of wheels 802, such as used on trains, adapted to rail road tracks 800 and capable of being retracted to allow travel on standard wheels 12. It should be appreciated that when traveling on rails, the forward or rearward motion of the vehicle 10 can preferably be provided through the rotation of the primary wheels 12, wherein the secondary wheels are only used as a guide to maintain vehicle 10 on the tracks, through the rotation of the secondary wheels 802 or a combination of power to both the primary wheels 12 and the secondary wheels 802. It should be understood that an adaption of this vehicle substantially to rail road travel (i.e. providing only the secondary train-type wheels 802 and not the primary wheels 12) is within the spirit of this invention. It should also be appreciated that the second set of wheels 802, 802A can be configured to fit any type or width of rail track depending on where the vehicle 10 will be utilized. It should further be understood that when utilizing wheels 802A, the power for rearward or forward motion is preferably provided through the primary wheels 12.

In an alternative embodiment, vehicle 10 is adapted for use in non-emergency and non-fire fighting situations. In particular, in the adaption of vehicle 10 for rail travel, the present device could be used for controlling vegetation and pests that frequently cause concern near railroad tracks. In particular, the foaming agent tank 44 could be converted to storing pesticides, insecticides, herbicides or other chemicals. When the pump 30 is energized, the chemical or chemicals in the foaming agent tank 44 are drawn into the discharge line 29 and the mix of water and some preferred chemical may be sprayed along the railroad tracks to control vegetation and pests. Another non-emergency and non-fire fighting embodiment is the use of the present device in preferably controlling vegetation and pests in areas not accessible by other vehicles. In this embodiment, vehicle 10 comprises wheels 12 but still carries pesticides, insecticides, herbicides or other chemicals in the foaming agent tank 44. This embodiment would be particularly adaptable to urban areas that have some wooded acreage near homes, business, hospitals, or the like, which need pest and vegetation control that is typically obtained by utilizing personnel on foot which is very time consuming and therefore expensive.

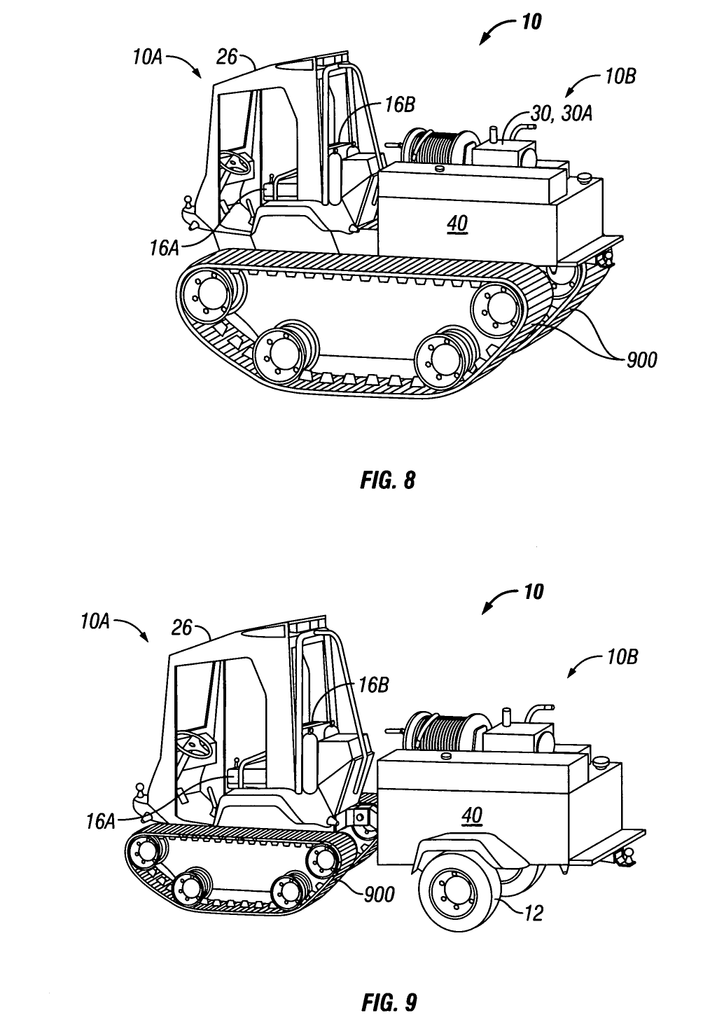

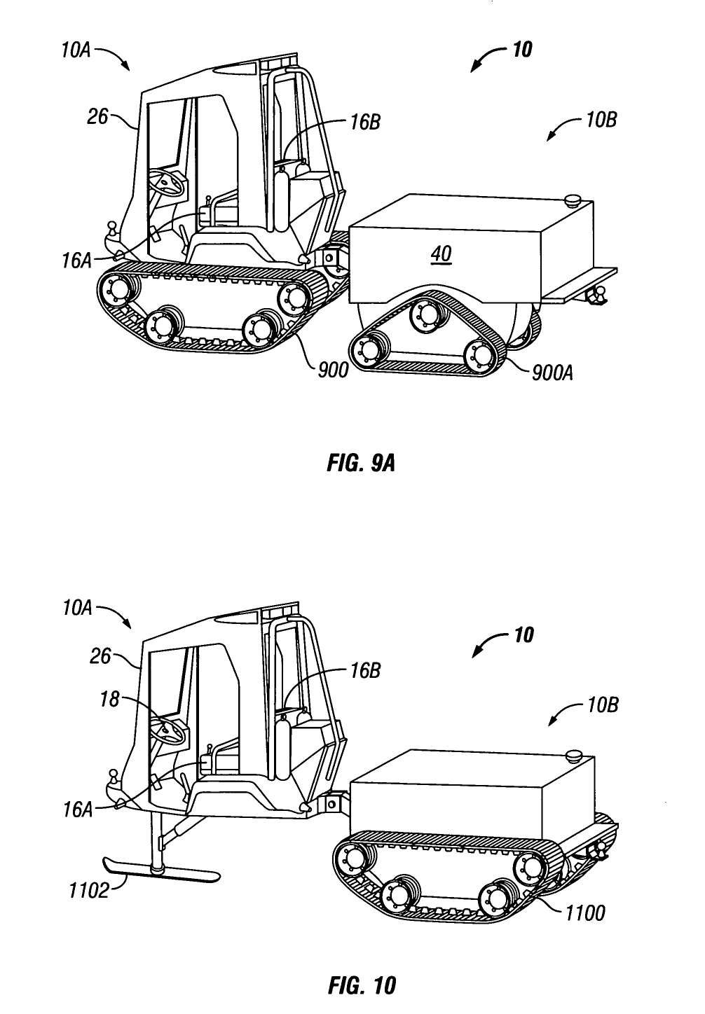

In another embodiment of the device, the wheels 12 can be replaced with tracks 900 as illustrated in FIG. 8. It should be appreciated that the tracks 900 are preferably endless belts such as employed on tanks or other military vehicles, tractors or other construction equipment, and the like. This will preferably allow the vehicle 10 to traverse areas where tire traction would be very poor, such as shifting or unstable soils or areas where tires would be damaged or destroyed. It should be appreciated that in an embodiment, such as illustrated in FIG. 8, an articulating joint 82 (FIG. 12) may not be necessary but preferably is still employed for reasons including, but not limited to, easy conversion from one embodiment to another, for overall interchangeability of maintenance and spare parts, and for avoiding the need to design other drive mechanisms. A variation of this embodiment is illustrated in FIG. 9 wherein only the front unit 10A is equipped with tracks 900 and the rear unit 10B preferably retains the articulating joint 82 (FIG. 12) as well as the wheels 12. A further variation is illustrated in FIG. 9A wherein the front unit 10A and rear unit 10B are both preferably equipped with an individual set of tracks 900, 900a. It should be understood that the embodiment illustrated in FIG. 9A preferably retains the articulating joint 82 (FIG. 12). Another embodiment, FIG. 10, illustrates yet another drive option to cover various terrain where the use of standard wheels 12 would be non-conducive to a particular environment. Here, the wheels 12 are replaced with tracks 1100 and the steering mechanism includes at least one ski-like device 1102. In this manner, this embodiment allows the vehicle 10 to traverse snow and/or ice covered terrain.

Because of the relatively light weight of the present device, as compared to traditional fire-fighting and rescue vehicles or even more compact units mounted on pickup trucks, it is understood that many of the disclosed embodiments could be air- lifted, for example by helicopter, into isolated areas located some distance from accessible roads such as, but not limited to, areas of forest fires, rescue operations in forests, swamps, mountainous areas, and the like. It should be understood that the light weight of the vehicle is, at least partially due to the vehicles compact size design and fiberglass body. However, other materials of construction are within the scope of this invention and should not be viewed as limiting.

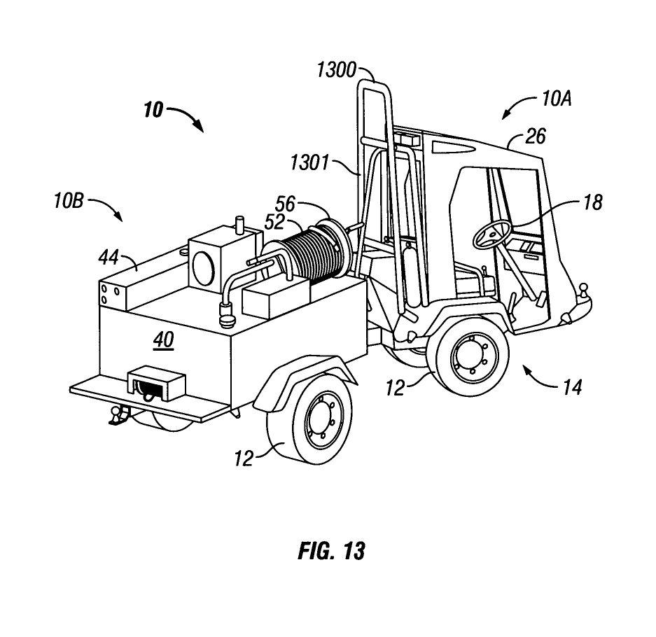

For such air-lift needs the vehicle 10 may be equipped with a sky hook 1300 (FIG. 13) attachment. Although not illustrated in detail, it is well known to those in the art, that such a skyhook 1300 would be positioned such that the center of gravity of the vehicle 10 would be aligned with the hook 1300 position such that the vehicle 10 could be raised, lowered, and carried without damage. If the vehicle 10 is to be air-lifted with all tanks fully loaded, it is preferred that the sky hook 1300 attachment be comprised of a separate frame 1301 that is attached to both the front unit 1OA and the rear unit 10B. It should also be appreciated that the embodiments for non fire-fighting vehicles and non-emergency or non-rescue vehicles could also comprise the sky hook 1300 attachment for air lifting the vehicle 10 to more remote areas. It should be further appreciated that vehicle 10 may be transported without skid 40a or that skid 40a and the vehicle 10 be transported separately. It should be understood that the sky hook 1300 can be utilized for lifting or moving the vehicle 10 by a variety of means including, but not limited to helicopters, cranes, and the like.

In operation, the vehicle 10 is preferably stored near the area to be served. However, it is more probable that the vehicle 10 will serve a large area, such as a county, a certain state or private park, a township, and the like. In this instance, vehicle 10 would preferably be stored on a trailer. When needed, the vehicle 10 would preferably be transported, by trailer, as close to the site requiring the vehicle 10 as possible (i.e. as close as accessible roads can reach). It should be appreciated that if the vehicle 10 is used for emergency operations the various tanks are preferable always full. After unloading, the foaming agent tank 44 is energized by opening the discharge valve. It should be noted that the foaming agent will preferably not flow freely from the foaming agent tank 44 discharge into the discharge line 29 until there is water flow in the discharge line 29 to create a venturi effect to urge the foaming agent into the discharge line 29. It should be appreciated that embodiments utilizing the Compressed Air Foaming System 81, utilized the compressed air in lieu of the venturi effect. The vehicle 10 and its occupants will preferably proceed to drive to the required location. In case of a fire, the pump 30 can be operating while the vehicle 10 is in motion. Thus, at least one occupant of the vehicle 10 can actually spray water and/or foam on a fire while the vehicle is in motion. Also in embodiments with spray nozzles 6 located underneath, in the front, in the back, or on the sides of the vehicle, the spray of water and/or foam can help protect the occupants of the vehicle 10 as well as put out the low ground fires and allow access closer to the heart of the fire. In the case of brush fires where the vegetation is short in height, spraying the fire while the vehicle 10 moves may allow a very quick extinguishing cycle.

In case of non-emergency uses, such as vegetation and pest control, the operation of the unit is substantially the same except for the chemicals which are preferably placed in the foaming agent tank 44. It should be understood that if the embodiment in use is for dispensing, spreading, or broadcasting any type of chemical or chemical mix then at least the foaming agent tank 44, which contains and dispenses the required chemical, is preferably empty until just prior to use. It should be appreciated that chemical spraying can also utilize embodiments featuring spray nozzles 6 mounted outside of the vehicle 10. It should be further appreciated that tank 40 could be directly filled with the desired chemical without the need of the foaming agent tank 44.

Those who are skilled in the art will readily perceive how to modify the present invention still further. For example, the combinations of features of the various embodiments can create other working embodiments without departing from the spirit of the invention. In addition, the subject matter of the present device should not be considered limited to a particular material of construction. Therefore, many materials of construction are contemplated by the present device including but not limited to metals, glass, rubbers, fiberglass, plastics, fire retardant materials, as well as combinations and variations thereof. As many possible embodiments may be made of the present invention without departing from the scope thereof, it is to be understood that all matter herein set forth or shown in the accompanying drawings is to be interpreted as illustrative and not in a limiting sense.

1. An all-terrain vehicle comprising:
a front unit having a first frame and a seating compartment, defined at least in part by said first frame, said seating compartment having at least one steering wheel for steering said front unit, and a rear unit having a second frame, said front unit and said rear unit being connected by an articulating joint, said articulating joint includes a drive shaft, wherein said front unit comprises at least one set of wheels and said rear unit comprises at least one set of wheels, and wherein said articulating joint, in combination with said at least one steering wheel, provides steering capability of said all-terrain vehicle while providing rotational capability to said at least one set of wheels on the front unit and said at least one set of wheels on the rear unit; and
said rear unit further comprising at least one fluid tank, at least one pump, at least one hose reel, and at least one generator, said pump being in fluid communication with said at least one fluid tank, wherein said generator provides power to said pump.

2. The all-terrain vehicle of claim 1, wherein said fluid tank defines at least one internal chamber, and wherein said internal chamber contains a quantity of fluid.

3. The all-terrain vehicle of claim 2, wherein said fluid is water.

4. The all-terrain vehicle of claim 1, further comprising a fuel tank for said generator, wherein said fuel tank is in fluid communication with said generator, and wherein said fuel tank provides fuel for operating said generator.

5. The all-terrain vehicle of claim 1, further comprising a foam mixing tank, wherein said tank is in fluid communication with said fluid tank, and at least one hose, said hose being in fluid communication with said fluid tank and said foam tank, wherein said foam mixing tank contains a foaming agent, and wherein said foaming agent has mixing capability with a fluid to create a foam for extinguishing fire.

6. The all-terrain vehicle of claim 5, further comprising at least one air tank, wherein said one air tank provides compressed air for a compressed air foam system, wherein said compressed air forces the foaming agent to mix with the fluid to create a foam for extinguishing fire.

7. The all-terrain vehicle of claim 1, further comprising at least one tank containing breathing air, wherein said tank can provide breathing air to persons when necessary.

8. The all-terrain vehicle of claim 1, further comprising a control panel, wherein said control panel provides energizing and de-energizing switches for at least said generator and said pump.

9. The all-terrain vehicle of claim 1, further comprising a roll cage, said roll cage substantially enclosing said first unit, wherein said roll cage provides protection to said occupants of said all-terrain vehicle.

10. The all-terrain vehicle of claim 9, further comprising doors, wherein said doors are detachably mounted to said roll cage, and wherein said doors provide egress and ingress capability for said front unit.

11. The all-terrain vehicle of claim 10, wherein said doors further comprise a fire retardant material, wherein said fire retardant material protect occupants of said all-terrain vehicle.

12. The all-terrain vehicle of claim 11, further comprising a fire retardant material disposed about said roll cage.

13. The all-terrain vehicle of claim 1, further comprising a personnel carrier, wherein said personnel carrier is detachably mounted on said all-terrain vehicle for carrying injured personnel or casualties.

14. The all-terrain vehicle of claim 13, wherein a cage substantially encloses said personnel carrier for protecting personnel being carried therein.

15. The all-terrain vehicle of claim 13, wherein said personnel carrier is detachably mounted on a back end of said rear unit.

16. The all-terrain vehicle of claim 13, wherein said personnel carrier is detachably mounted on a front end of said front unit.

17. The all-terrain vehicle of claim 13, wherein said personnel carrier is detachably mounted, at least partially, on a side of said front unit.

18. The all-terrain vehicle of claim 1, further comprising at least one additional unit, wherein the additional unit comprises at least one set of wheels, and wherein the additional unit is detachably connected to said rear unit.

19. The all-terrain vehicle of claim 18, wherein said at least one additional unit is a trailer.

20. The all-terrain vehicle of claim 18, wherein said at least one additional unit is detachably mounted via a receiver hitch.

21. The all-terrain vehicle of claim 18, wherein said at least one additional unit is detachably mounted to a front end of said front unit.

22. The all-terrain vehicle of claim 1, further comprising at least one receiver hitch, mounted on said front unit, said receiver hitch having detachable coupling capability to an additional apparatus.

23. The all-terrain vehicle of claim 1, further comprising at least one receiver hitch, mounted on said rear unit, said receiver hitch having detachable coupling capability to an additional apparatus.

24. The all-terrain vehicle of claim 1, further comprising at least one winch mounted on said front unit.

25. The all-terrain vehicle of claim 1, further comprising at least one winch mounted on said rear unit.

26. The all-terrain vehicle of claim 1, wherein said fluid tank defines an inner chamber, said inner chamber containing chemicals or pesticides, and wherein said chemicals or pesticides can be sprayed to control insects or vegetation.

27. The all terrain vehicle of claim 1, further comprising a G.P.S. system, wherein said G.P.S. system provides navigational assistance and/or vehicle positioning.

28. An all-terrain vehicle comprising:
a front unit having a first frame and a seating compartment, defined at least in part by said first frame, said seating compartment having at least one steering wheel for steering said front unit, and a rear unit having a second frame, said front unit and said rear unit being connected by an articulating joint, said articulating joint includes a drive shaft, wherein said front unit comprises at least one set of wheels and said rear unit comprises at least one set of wheels, and wherein said articulating joint, in combination with said at least one steering wheel, provides steering capability of said all-terrain vehicle while providing rotational capability to said at least one set of wheels on the front unit and said at least one set of wheels on the rear unit;
said rear unit further comprising at least one fluid tank, at least one pump, at least one hose reel, and at least one generator, said pump being in fluid communication with said at least one fluid tank, wherein said generator provides power to said pump; and
at least one set of wheels adapted for travel on railroad tracks.

29. The all-terrain vehicle of claim 28, wherein said at least one set of wheels adapted for travel on railroad tracks are detachably mounted to an outside surface of each set of wheels of said front unit and said rear unit.

30. The all-terrain vehicle of claim 28, wherein said at least one set of wheels adapted for travel on railroad tracks are detachably mounted to an inside surface of each set of wheels of said front unit and said rear unit.

31. An all-terrain vehicle comprising:
a front unit having a first frame and a seating compartment, defined at least in part by said first frame, said seating compartment having at least one steering wheel for steering said front unit, and a rear unit having a second frame, said front unit and said rear unit being connected by an articulating joint, said articulating joint includes a drive shaft, wherein said front unit comprises at least one set of rotationally capable support apparatus and said rear unit comprises at least one set of rotationally capable support apparatus, and wherein said articulating joint, in combination with said at least one steering wheel, provides steering capability of said all-terrain vehicle while providing rotational capability to said at least one set of a rotationally capable support apparatus on the front unit and said at least one set of a rotationally capable support apparatus on the rear unit; and
said rear unit further comprising at least one fluid tank, at least one pump, at least one hose reel, and at least one generator, said pump being in fluid communication with said at least one fluid tank, wherein said generator provides power to said pump.

32. The all-terrain vehicle of claim 31, further comprising a set of tracks mounted between the rotationally capable support apparatus of the front unit with the rotationally capable support apparatus of the rear unit, wherein said tracks provides traction to allow forward and rearward movement of said vehicle.

33. The all-terrain vehicle of claim 31, wherein a set of tracks are adapted to the rotationally capable support apparatus of said front unit, and wherein said rear unit comprises at least one set of wheels adapted to the rotationally capable support apparatus of said rear unit.

34. The all-terrain vehicle of claim 31, wherein a first set of tracks are adapted to the rotationally capable support apparatus of said front unit, and wherein a second set of tracks are adapted to the rotationally capable support apparatus of said rear unit, wherein said tracks provide traction to allow forward and rearward movement to said vehicle.

35. The all-terrain vehicle of claim 31, wherein said front unit comprises a ski unit and said rear unit comprises a set of tracks adapted to the rotationally capable support apparatus of the rear unit, wherein said ski unit and said set of tracks provide traction in adverse cold weather conditions.

36. An all-terrain vehicle comprising:
a front unit having a first frame and a seating compartment, defined at least in part by said first frame, said seating compartment having at least one steering wheel for steering said front unit, and a rear unit having a second frame, said front unit and said rear unit being connected by an articulating joint, said articulating joint includes a drive shaft, wherein said front unit comprises at least one set of wheels and said rear unit comprises at least one set of wheels, and wherein said articulating joint, in combination with said at least one steering wheel, provides steering capability of said all-terrain vehicle while providing rotational capability to said at least one set of wheels on the front unit and said at least one set of wheels on the rear unit;
said rear unit further comprising at least one fluid tank, at least one pump, at least one hose reel, and at least one generator, said pump being in fluid communication with said at least one fluid tank, wherein said generator provides power to said pump; and
a sky hook, wherein said sky hook is fixedly attached to said first frame, and wherein said sky hook provides the capability of airlifting said all-terrain vehicle when desired.

37. The all-terrain vehicle of claim 36, wherein said skyhook is fixedly mounted to said first frame and to said second frame, thus providing the capability of airlifting said all-terrain vehicle.

38. An all-terrain vehicle comprising:
a front unit having a first frame and a seating compartment, defined at least in part by said first frame, said seating compartment having at least one steering wheel for steering said front unit, and a rear unit having a second frame, said front unit and said rear unit being connected by an articulating joint, said articulating joint includes a drive shaft, wherein said front unit comprises at least one set of wheels and said rear unit comprises at least one set of wheels, and wherein said articulating joint, in combination with said at least one steering wheel, provides steering capability of said all-terrain vehicle while providing rotational capability to said at least one set of wheels on the front unit and said at least one set of wheels on the rear unit;
said rear unit further comprising a removable skid; and
said rear unit further comprising at least one fluid tank, at least one pump, at least one hose reel, and at least one generator mounted on said removable skid, said pump being in fluid communication with said at least one fluid tank, wherein said generator provides power to said pump.
